(19) United States
(12) Patent Application Publication
(10) Pub. No.: US 2010/0288274 A1
(43) Pub. Date: Nov. 18, 2010

(54) Illuminated Self Contained Breathing Apparatus

(76) Inventor: Jack F. Hudson, Tequesta, FL (US)

Correspondence Address: MCHALE & SLAVIN, P.A., 2855 PGA BLVD, PALM BEACH GARDENS, FL, 33410, US

(21) Appl. No.: 12/779,425

(22) Filed: May 13, 2010

Related U.S. Application Data
(60) Provisional application No. 61/177,722, filed on May 13, 2009.

(51) Int. Cl. A62B 7/00; G09F 13/04

(52) U.S. Cl. 128/202.13; 40/564

(57) ABSTRACT

A device for use with a self contained breathing apparatus, such as a SCBA tank, which allows a user to display different indicia on the tank. The indicia are preferably illuminated by a self contained illumination system also located on the tank. The device allows a user to readily interchange the indicia so that the currently displayed indicia provide a specific message or indicate a specific condition to an individual observing the tank and related indicia. The illumination system permits the indicia on the tank to be clearly seen in poorly lighted environments, such as deep underwater, or in environments with poor visibility, such as in smoke-filled rooms associated with fires.

### CROSS REFERENCE TO RELATED APPLICATION

The present application claims the benefit of priority under 35 U.S.C. §119(e) to U.S. Provisional Patent Application No. 61/177,722, filed May 13, 2009, and entitled, “Illuminated Air Supply Tank”, the contents of which are incorporated herein by reference.

### FIELD OF THE INVENTION

The present invention relates to indicators for self contained breathing devices. In particular, the indicators are secured to the outside of the breathing devices and illuminated. The indicators include indicia which are readily recognized by individuals associated with a particular activity that employs the self contained breathing devices.

### BACKGROUND OF THE INVENTION

Self contained breathing devices provide individuals the ability to explore certain environments that are not conducive to normal human physiology. Self contained underwater breathing apparatus, or SCUBA tanks and systems are widely used by professional and sport underwater divers. In addition, self contained breathing apparatus, SCBA, are used by emergency workers such as fireman, first aid responders, industrial hazard material workers, military personnel and other individuals who enter environments in which the air is not readily breathable. One of the problems associated with humans interacting within these types of environments is a decreased ability to communicate with fellow divers or emergency personnel. Given the extreme dangers associated with the environments, the need to communicate can be vital to effectively and safely perform a task or save the life of another.

Diving in open waters exposes humans to different environments and creatures. In addition to normal daylight dives, night time dives or cave exploration further exposes divers to a variety of creatures that are not visible during the day or in open waters. As any experienced diver knows, the deeper the dive, the darker the environment. Common equipment for divers intending to experience such environments therefore must include some type of light source. Typical light sources include dive lights, probes, or chemiluminescent sticks. While such equipment is common, use of these lighting options has several disadvantages. The lighting devices used by divers are mostly hand held lights which, if not held/or attached properly to the dive suit, are easily dropped. Given the depth of the ocean, such lighting devices provide limited visibility which makes it difficult to communicate with fellow divers.

Since night dives tend to be dangerous, it is not uncommon for divers to travel in groups. If several members of the group get separated, it may be impossible for one diver to visualize other divers beyond his/her own light beam. Unless a diver is in the direct beam of a light source, communication between fellow divers is difficult. Moreover, when traveling in groups, divers run the risk of becoming temporarily blinded should he/she accidentally be exposed to the beam of light being carried by a fellow diver. Because divers are unable to utilize verbal communications underwater, it is imperative that divers find other means of communication to ensure the safety of other members of the group. The dark waters generally prohibit the divers from using hand signals as a means of communication. As such, divers have developed other means of communication. For instance, moving a light source up and down signals distress and a need for help. Forming circles with the light source indicates that the diver is safe. These techniques can be useful when the diver is capable of visualizing the light source. However, such visualization is not always clear and the diver either fails to see the signal or is confused as to what is being conveyed, resulting in either delay in rescue because the diver can not interpret the signal, or a waste of precious oxygen when the diver incorrectly interpreted a signal and goes to check it out.

Firefighters entering burning buildings face similar concerns as divers exploring the deep, dark waters. Firefighters entering smoke filled buildings are faced with severely restricted visibility. Given the extreme environments that emergency personnel face, properly identifying and tracking those who enter such environments are of extreme importance. In this environment, it is also vital that firefighters have some type of contact with fellow firefighters. While communication devices can be used, poor signal in buildings decreases the effectiveness of these devices. Common markings, such as reflective tape or light devices, are often integral aspects of the firefighter's gear. However, reflective tape and lighting devices are limited and are not always visualized by other firefighters in smoke filled environments. The types of messages and information that can be relayed to a third party are also limited.

Therefore, what is needed is a notification device that attaches to self contained breathing apparatus and which provides clearly visible messages and information about the user to third parties.

### SUMMARY OF THE INVENTION

The instant invention describes a device for use with self-contained breathing devices, such as a SCUBA tank, which allows a user to display different indicia on the tank. The indicia are preferably illuminated by a self contained illumination system also located on the tank. The device allows a user to readily interchange the indicia so that the currently displayed indicia provide a specific message or indicate a specific condition to a third party individual observing the tank and related indicia. The illumination system permits the indicia on the tank to be clearly seen deep underwater where it is dark, and in smoke-filled environments, such as in a fire, where visibility is minimal.

In a particular embodiment of the invention, the device is constructed and arranged to attach to the surface of a self contained breathing apparatus and illuminate a message that is viewable to a third party. The device comprises a main body having an outer frame. The outer frame is constructed and arranged to receive and hold an inner plate member. The inner plate member contains one or more types of indicia, such as words or symbols. At least one light source is electrically coupled to a power source for illuminating the inner plate member, whereby illumination of the inner plate member displays a message which is visible to a third party.

The instant invention also describes a system for illuminating the surface of a self contained breathing apparatus in such a manner so as to convey a message to a third party. The system comprises a notification device in the form of a net. The net is constructed and arranged in a matrix arrangement of flexible material including an array of intersecting rows and columns defining a plurality of open spaces. The net attaches to or can be placed around a self contained breathing apparatus. The system also includes at least one electrical lead interlaced within the net and coupled to a power source and at least one light source coupled to the at least one electrical lead.

In an alternative embodiment, the system for illuminating the surface of a self contained breathing apparatus in such a manner so as to convey a message to a third party comprises a notification device having a first inner housing member attached to a self contained breathing apparatus. The first inner housing member is constructed and arranged to receive an inner sheath member. The system further includes a second outer housing member constructed and arranged to receive an outer sheath member. An inner sheath member is attached to the first inner housing member and an outer sheath member is attached to the second outer housing member. The outer sheath member contains indicia. The system further includes at least one light source electrically coupled to a power source for illuminating the outer sheath member, whereby illumination of the outer sheath member displays a message which is visible to a third party.

Accordingly, it is an objective of the instant invention to provide a device which includes a frame, the frame being secured to a contained breathing apparatus and having indicia which may contain a message that is sized to fit within the frame and be clearly displayed.

It is a further objective of the instant invention to provide a device which includes a frame, the frame being secured to a self contained breathing apparatus and which is constructed to enable the quick change of indicia within the frame.

It is yet another objective of the instant invention to provide a device which includes a frame, the frame being secured to a self contained breathing apparatus and having a device for illuminating the frame and the indicia within the frame.

It is yet another objective of the instant invention to provide a device which includes a frame, the frame being secured to a self contained breathing apparatus and having a device for providing a reflective border surrounding the frame.

It is a still further objective of the invention to provide a device which includes a frame, the frame being secured to a self contained breathing apparatus and having a device for illuminating the entire perimeter of the frame and any indicia contained within the frame.

It is still yet a further objective of the invention to provide a device which includes a frame, the frame being secured to a self contained breathing apparatus and having a device for illuminating the frame and indicia within the frame which is covered by a lens.

It is yet another objective of the instant invention to provide a system for illuminating a self contained breathing apparatus; the system including a net having a matrix arrangement of flexible material including an array of intersecting rows and columns defining a plurality of open spaces and containing one or more light sources.

It is yet another objective of the instant invention to provide a system for illuminating a self contained breathing apparatus, the system including a notification device having a first housing member attached to a self contained breathing apparatus and constructed and arranged to receive an inner sheath member, a second housing member constructed and arranged to receive an outer sheath member, an inner sheath member attached to the first inner housing member and an outer sheath member having indicia and attached to the second housing member and at least one light source electrically coupled to a power source for illuminating the outer sheath member whereby Illumination of the outer sheath member displays a message which is visible to a third party.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front view of the notification device of the instant invention which is secured to a self contained breathing apparatus;

FIG. 2A illustrates the indicia in the form of a symbol;

FIG. 2B illustrates an alternative embodiment of the indicia;

FIG. 2C illustrates the indicia in the form of words;

FIG. 2D illustrates the indicia having multiple messages;

FIG. 3 is a back view of the notification device of the instant invention;

FIG. 4 is a perspective view of the notification device secured to SCUBA tank;

FIG. 5 illustrates the notification device of the instant invention secured to a self contained breathing apparatus, SCBA, typically used by firefighters;

FIG. 6 is a front view of an alternative embodiment of the instant invention secured to a self contained breathing apparatus;

FIG. 7 is a bottom perspective view of the alternative embodiment illustrated in FIG. 6;

FIG. 8 is an enlarged view of the net arrangement, electrical leads, and light source of the alternative embodiment of the instant invention as described in FIG. 6;

FIG. 9 is an illustration of an alternative embodiment of the notification device of the instant invention having multiple sheath members; and

FIG. 10 illustrates indicia positioned on the outer sheath member.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

With reference to the drawings, and in particular FIGS. 1-3, a preferred embodiment of the instant invention will now be described. A notification device or display device 10 is shown in FIG. 1 secured to a side of a self contained breathing apparatus 12, such as a SCUBA tank. The notification device 10 is preferably curved in its longitudinal cross section to conform to the outer curvature of the tank 12. This curvature permits the device 10 to be readily secured to the tank 12 and remain affixed thereon.

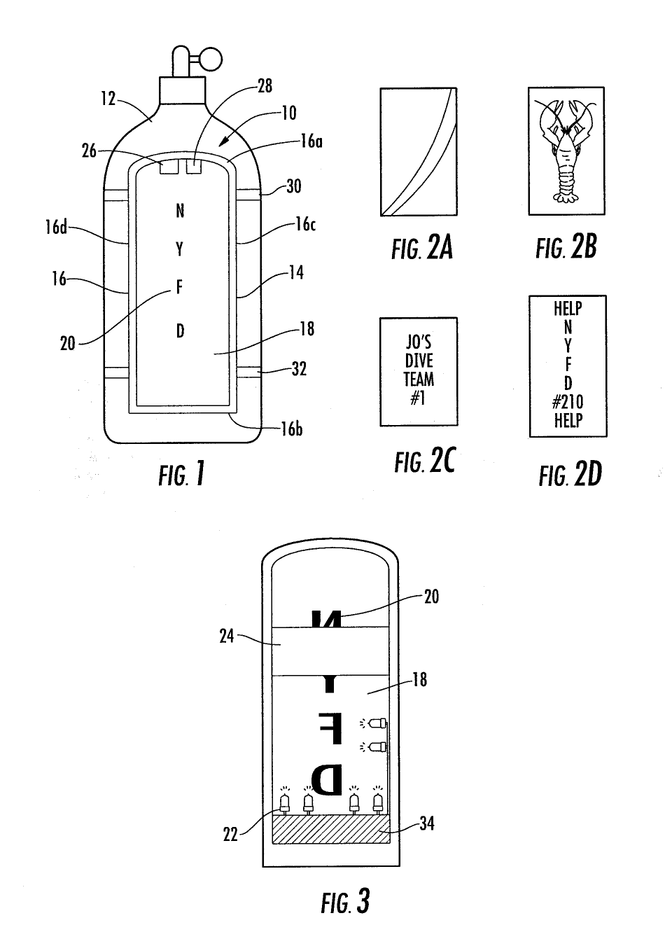

The notification device 10 includes a main body 14 which is defined by an outer frame 16. The outer frame 16 is designed to receive and hold an inner plate member 18. Inner plate member 18 is preferably transparent or translucent. As illustrated in FIGS. 1 and 3, the outer frame has a top wall 16a and a parallel bottom wall 16b. While the two parallel side walls 16c and 16d interconnect with the top wall 16a and bottom wall 16b to give the outer frame a generally rectangular shape, the notification device 10 need not be limited to such a shape. The inner plate member 18 contains indicia 20. Indicia 20 includes a plurality of lettering, however, the indicia may also include symbols, one or more words, or combinations thereof. For example, the indicia can be a symbol such as a diagonal stripe illustrated in FIG. 2A, which is the symbol for underwater divers, or a graphic symbol, such as a lobster, see FIG. 2B. FIGS. 2C and 2D illustrate the indicia in the form of a plurality of words. The inner plate member 18 can be designed to slidably engage the frame, such as for example, through slots or grooves within the frame. This provides the user the ability to easily and quickly interchange one or more inner plate members having different indicia. Once within the frame, the indicia are clearly displayed and can be seen by other individuals in sight of the self contained breathing apparatus 12. Preferably the indicia are translucent so that they can be illuminated by light contained on the tank. The indicia can also be transparent and/or opaque. The main purpose of the indicia is to convey a message to a third party observing the tank 12 from a distance. The message that is conveyed relates to the individual wearing the tank.

FIG. 3 is a view of the inner side of the notification device 10. A plurality of lights 22 is located within the frame 16 at one end thereof. The frame is spaced from the surface of the tank so that when one of the indicia 2A-2D is placed within the frame, lights 22 are positioned between the indicia and the surface of the tank. Thus the indicia are illuminated by the lights. The lights 22 are preferably Light Emitting Diodes (LED). The lights 22 can be clear of any other color, or can be different colors. The lights 22 can be illuminated all together or can be controlled such that they flash, blink or are illuminated in any given pattern. In addition to, or in lieu of the lights 22, the notification device 10 could also contain a flat light 24. The flat light 24 can be located within the perimeter of the frame or between the indicia and the surface of the tank.

In order to increase the visibility of the notification device 10, the outer frame 16 can also be made of a material that is reflective or that can be illuminated under specific lighting conditions, such as ultra-violet lights. The notification device 10 is preferably positioned on tank 12 so that it is clearly visible to one or more individuals. The size of the notification device can be selected so that it can be visible by photographic detectors, such as cameras, and/or visual, infrared, ultraviolet, optical, scanning devices. Attached to the notification device 10 are various communications receiving and/or transmitting elements, 26 and 28. Elements 26 and 28 can also be transceivers. For example, elements 26 and 28 may provide audio or acoustic signal. The notification device 10 can also be provided with communication capabilities which can send a signal to a remote location, such as a home base, that the individual wearing the notification device needs assistance. Communications receiving and/or transmitting elements 26 or 28 may include a Global Positioning System (GPS) device. The GPS device enables the individual wearing the notification device 10 to be tracked and located whenever desired, such as in case of an emergency. In an emergency situation the notification device 10 can function like an OnStar® device. The notification device 10 is secured to the tank 12 through various attachment straps 30 and 32, which include hook and loop fasteners, such as VELCRO®, bungee cords, clasps, or other fastening means known to one of skill in the art.

A source of electrical energy 34 is preferably located at one end of the frame 16. In a preferred embodiment the source of electrical energy 34 is one or more batteries. The batteries can be single use or rechargeable. In place of the batteries, a solar panel or other devices which generate electricity can be employed to illuminate the lights 22 and 24.

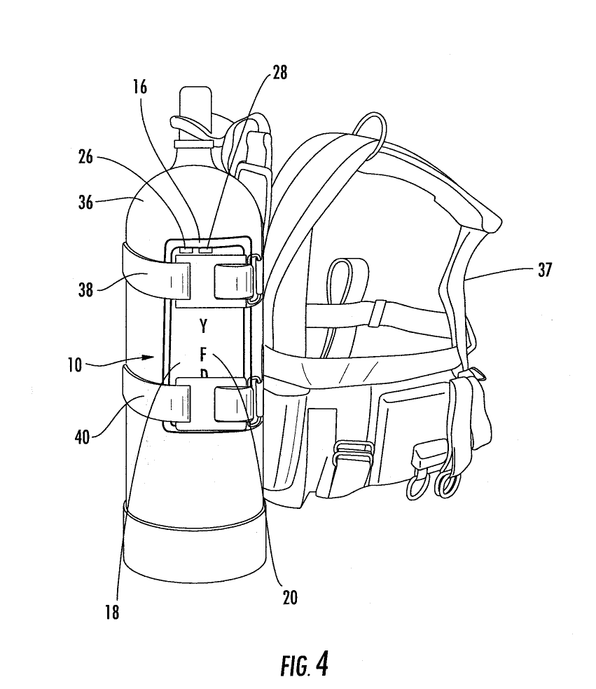

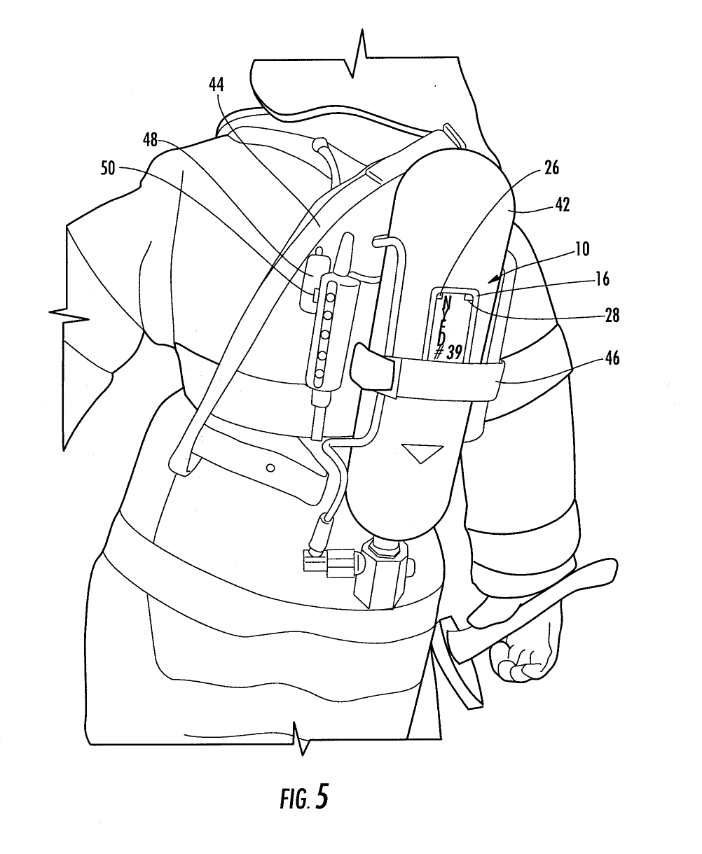

FIG. 4 is a prospective view of the notification device 10 secured to a conventional SCUBA tank 36 and harness 37. Horizontal straps 38 and 40 which secure the harness 37 to the tank 36 are normally spaced a standardized distance apart. The instant invention is preferably positioned between the straps 38 and 40. The straps can also be used to secure frame 16 to tank 36. The notification device 10 is preferably positioned on tank 12 so that it is clearly visible to one or more individuals. The size of the notification device 10 can be selected so that it can be visible by photographic detectors, such as cameras; and/or visual, infrared, ultraviolet, optical, scanning devices. The notification device 10 can also include an audio or acoustic signal. The notification device 10 can also be provided with communication capabilities which can send a signal to a remote location, such as a home base, that the individual wearing the notification device needs assistance. The notification device 10 can also be provided with a Global Positioning System (GPS). The GPS device enables the individual wearing the notification device 10 to be tracked and located whenever desired, such as in case of an emergency. In one type of situation, the individual wearing the notification device can indicate to a third party, such as OnStar®, that they will be returning to a specific location at a certain time. If the individual does not return by that time, the third party will notify persons that the individual has requested to be notified in case of an emergency. These persons can then check the location of the individual in distress by accessing the GPS device secured to the individual.

The notification device 10 used in conjunction with a SCUBA tank also enables the tracking of the individual associated with the notification device by sonar or other devices from the surface of the water or under the surface of the water. This tracking capability allows a third party to determine the location of the individual in the event of an emergency. Although not shown, all or any portion of the notification device 10 as described herein can be enclosed within a waterproof container to protect one or all portions of the device from aquatic environments.

Although not illustrated, the notification device 10 may also contain a control panel. The control panel could be electrically connected to the one or more light sources or the power source such that various portions of the notification device or colors of light could be illuminated upon activation. For example, the indicia as illustrated in FIG. 2D could be used by firefighters either in an underwater recovery rescue or in a burning building. Once inside the particular environment, the indicia could be illuminated such that ‘NYFD #210” could be illuminated. This provides non-verbal communication to other firefighters as to who is around them. If firefighter #210 gets injured and needs help, the firefighter could activate the control panel. The activation results in illuminating the “HELP” section of the notification device, thereby alerting fellow firefighters, whom may have limited visibility, that #210 needs help. Additionally, the notification device 10 may also flash red colored lights once activated by the control panel. The notification device can further be programmed to contact a third party, such as On Star®, which will contact specific individuals, as stated herein above.

A conventional SCBA tank 42 and harness 44, commonly used by firefighters, are illustrated in FIG. 5. Horizontal strap 46 secures the harness 44 to the tank. The notification device 10 is preferably positioned substantially parallel to and adjacent tank 42. The notification device 10 is preferably positioned on tank 42 so that it is clearly visible to one or more individuals. The size of the notification device can be selected so that it can be visible by photographic detectors, such as cameras; and/or visual, infrared, ultraviolet, optical, scanning devices. The notification device 10 can also include an audio or acoustic signal. Strap 46 can be employed to help secure frame 16 to the tank 42.

The notification device 10 utilized with the SCBA tank 42 can be connected to or in communication with a device 48, such as a dead man's device, that detects the position and movement of the individual wearing the SCBA apparatus. In the event that the individual became injured or trapped in a non-vertical position, the detection device 48 would activate the notification device 10 by way of communications receiving and/or transmitting elements, 26 and 28 causing the lights to flash, blink, or emit a different color, thus alerting someone nearby. The notification device 10 can also be provided with a Global Positioning System (GPS) device 50. The GPS device 50 enables the individual wearing the notification device 10 to be tracked and located whenever desired, such as in case of an emergency. Communication and transmitting elements 26 and 28 operate in conjunction with a GPS device 50 which will determine the exact location of the individual wearing the notification device. In the event the detection device 48 determines that the individual wearing the notification device 10 is in danger, the communication devices 26 and 28 can send a signal which will notify a base station or other individual that someone needs assistance. The GPS device 50 will enable the individuals who have been notified by the communications devices 26 and 28 to determine the exact location of the individual who is in danger.

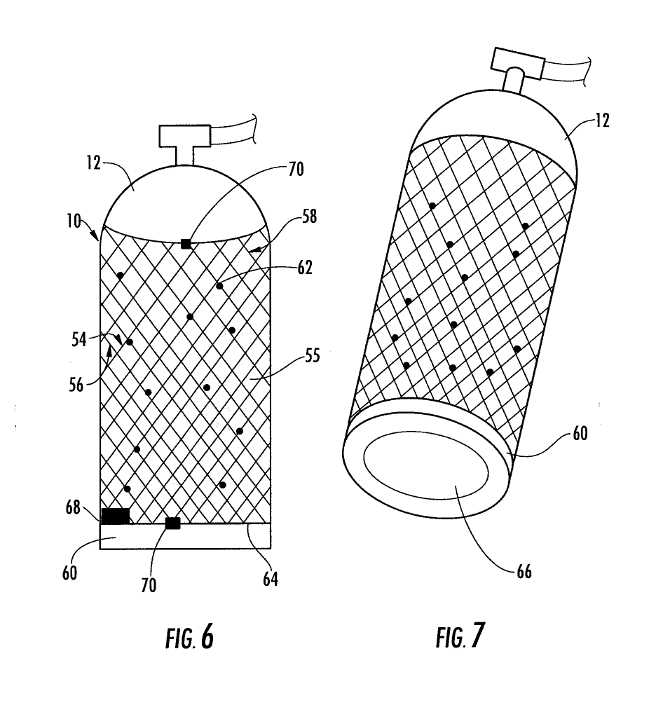

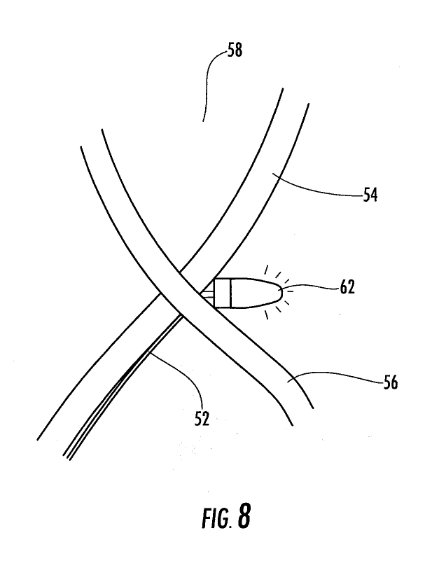

An alternative embodiment of the notification device 10 is illustrated in FIGS. 6 and 7. In this embodiment the self contained breathing apparatus 12 is placed into a net or woven matrix of elements. The net or woven matrix of elements can be constructed of flexible material. As shown in FIGS. 6, 7 and 8, one or more electrical leads 52 are interlaced within rows 54 or columns 56 of the woven net 58. The electrical leads 52 may run alongside a row 54 or a column 56, or the leads 52 may intersect through the open spaces 55. Each electrical lead 52 is connected in a bundle to a power source 60 on one end and on the opposite end to a light source 62. Preferably, each electrical lead 52 terminates at the intersection of a row 54 and a column 56. At the intersection, the electrical lead 52 is coupled to a light source 62. The light source 62 is preferably any low-wattage light emitting device, such as but not limited to a light emitting diode (LED). The power source 60 for use with the lit notification device 10 is preferably a battery pack which is attached to the net 58 on the outer bottom edge 64. Additional power sources can be employed. A separate light 66 is secured to the bottom of the power source 60 (FIG. 7). This light enables an individual to see it when the individual is swimming behind an individual wearing the notification device 10.

As shown in FIGS. 6-8, each light source 62 is coupled to an electrical lead 52 and positioned at the intersection of the rows 54 and columns 56 on the matrix arrangement of the woven net 58. However, it is contemplated that the leads 52 may also extend further from the intersection and into the open space and the light source 62 would be coupled in the open space, not shown. The light sources 62 can be coupled to a control switch 68 which allows the light source 62 to emit a spectrum of colors. Each light source 62 may transition between spectrums of color controlled by the control switch 68, for instance a multi-color LED; or each independent light source 62 may be of different spectrums to provide various color arrangements on the net 58. For instance, the light sources 62 may emit a white light for ordinary purposes, but in emergency situations a red light would be emitted to alert others of an emergency. Furthermore, the controller 68 may selectively light different zones within the net 58 to provide a variety of patterns or symbols by selectively lighting certain light sources 62 within a zone.

The notification device 10 may also include mounting elements 70 for attachment to the surface of the self contained breathing apparatus or for securing one portion of the device to a second portion. Various mounting elements are contemplated for securing the notification device 10 to the surface, such as suction cups, bungee cords, grommets, clasps, standing posts, weights, or hook and loop fasteners, such as VELCRO®.

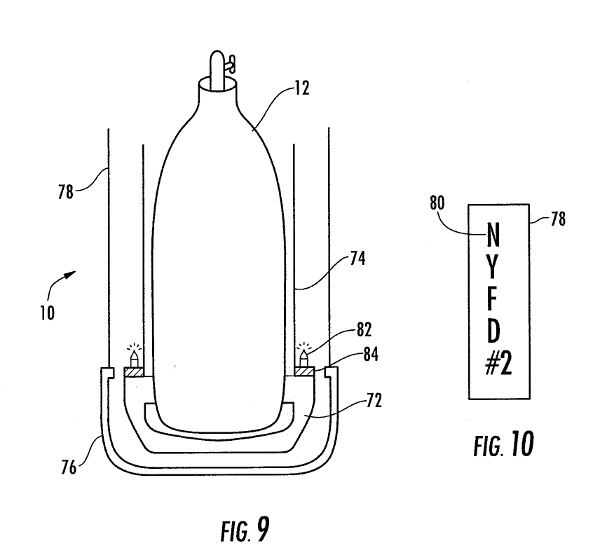

FIG. 9 illustrates an alternative embodiment of the notification device 10 which is secured to a self-contained breathing apparatus 12. The notification device 10 includes one or more sheath members constructed and arranged to provide notification functionality as described in previous embodiments. Attached to the self-contained breathing apparatus 12 is a first inner housing member 72. The first inner housing member 72 is constructed and arranged to receive an inner sheath member 74. A second outer housing member 76 is constructed and arranged to receive an outer sheath member 78. Inner sheath member 74 and outer sheath member 78 may be constructed of a translucent thermoplastic material, such as PLEXIGLAS®, and take the form of parallel, vertical panels extending in an upward direction from the first inner housing member 72 and the second outer housing member 76, respectively. Additionally, the inner sheath member 74 and/or the outer sheath member 78 may be designed to contour the outer perimeter of the self-contained breathing apparatus 12. The outer sheath member 78 of notification device 10 contains indicia 80, see FIG. 10, which provides identification and information about the user to a third party. As described previously, indicia 80 can be symbols, letters, words or combinations thereof.

The notification device 10 contains a plurality of lights 82, which may be positioned at or near the first inner housing member 72, on the inner sheath member 74, or combinations thereof. The plurality of lights, therefore, is preferably positioned between the inner sheath member 74 and the outer sheath member 78. In this arrangement, the plurality of lights 82 illuminates the indicia 80 that is located on the outer sheath member 78. The lights 82 are preferably Light Emitting Diodes (LED) and can be clear of any other color, or can be different colors. The lights 82 can be illuminated all together or can be controlled such that they flash, blink or are illuminated in any given pattern. The lights 82 are electrically coupled to a source of electrical energy 84 for illuminating the outer sheath member 78, whereby illumination of the outer sheath member displays a message which is visible to a third party. The source of electrical energy 84 is preferably located on the first housing member 72 but may be positioned on the inner sheath member 74. In a preferred embodiment, the source of electrical energy 84 is one or more batteries. The batteries can be single use or rechargeable. In place of the batteries, a solar panel or other devices which generate electricity can be employed to illuminate the plurality of lights 82.

Although not illustrated in FIG. 9, the notification device 10 can also be provided with communication capabilities which can send a signal to a remote location, such as a home base, that the individual wearing the notification device needs assistance. The notification device 10 can also be provided with a Global Positioning System (GPS). The GPS device enables the individual wearing the notification device 10 to be tracked and located whenever desired, such as in case of an emergency.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device which attaches to the surface of a self contained breathing apparatus and illuminates a message that is viewable to a third party comprising:
a main body having an outer frame, said outer frame constructed and arranged to receive and hold an inner plate member;
an inner plate member having indicia; and
at least one light source electrically coupled to a power source for illuminating said inner plate member, whereby illumination of said inner plate member displays a message which is visible to a third party.

2. The device according to claim 1 wherein said at least one light source is positioned within said outer frame.

3. The device according to claim 1 further including a second light source positioned within the perimeter of said outer frame.

4. The device according to claim 1 wherein said power source is a battery.

5. The device according to claim 1 wherein said inner plate member contains one or more letters, words, symbols, or combinations thereof.

6. The device according to claim 1 wherein said at least one illuminating source is positioned behind said inner plate member having indicia.

7. The device according to claim 1 further including a transceiving device.

8. The device according to claim 7 wherein said transceiving device is in communication with a motion and position sensor.

9. The device according to claim 7 wherein said transceiving device is in communication with a global positioning system device.

10. The device according to claim 1 wherein said outer frame is shaped to conform to a self contained breathing apparatus.

11. A system for illuminating a self contained breathing apparatus whereby such illumination conveys a message to a third party comprising:
a notification device in the form of a net, said net having a matrix arrangement of flexible material including an array of intersecting rows and columns defining a plurality of open spaces, said net being attached to a self contained breathing apparatus;
at least one electrical lead interlaced within said net and coupled to a power source;
at least one light source coupled to said at least one electrical lead, and a self contained breathing apparatus.

12. The system for illuminating a self contained breathing apparatus of claim 11, wherein said net includes a mounting element for attachment to the surface of said self contained breathing apparatus.

13. The system for illuminating a self contained breathing apparatus of claim 11, wherein said at least one electrical lead is interlaced within said row or said column in said matrix arrangement of said net.

14. The system for illuminating a self contained breathing apparatus of claim 13, wherein said at least one light source is positioned at said intersection of said rows and columns.

15. The system for illuminating a self contained breathing apparatus of claim 11, wherein said at least one light source is positioned within said open spaces.

16. The system for illuminating a self contained breathing apparatus of claim 11 further includes a plurality of light sources.

17. The system for illuminating a self contained breathing apparatus of claim 16, wherein said plurality of light sources emits a white light, multi-colored light, or combinations thereof.

18. The system for illuminating a self contained breathing apparatus of claim 11, wherein said at least one light source is coupled to a control switch.

19. A system for illuminating a self contained breathing apparatus whereby such illumination conveys a message to a third party comprising:
a notification device having a first inner housing member attached to a self contained breathing apparatus, said first inner housing member constructed and arranged to receive an inner sheath member, and a second housing member constructed and arranged to receive an outer sheath member;
an inner sheath member attached to said first inner housing member;
an outer sheath member attached to said second outer housing member, said outer sheath member having indicia;
at least one light source electrically coupled to a power source for illuminating said outer sheath member, whereby illumination of said outer sheath member displays a message which is visible to a third party; and a.
a self contained breathing apparatus.

20. The system for illuminating a self contained breathing apparatus whereby such illumination conveys a message to a third party according to claim 19 wherein said at least one light source is positioned between said inner sheath member and said outer sheath member.

21. The system for illuminating a self contained breathing apparatus whereby such illumination conveys a message to a third party according to claim 19 wherein said power source is a battery.

22. The system for illuminating a self contained breathing apparatus whereby such illumination conveys a message to a third party according to claim 19 wherein said outer sheath member contains one or more letters, words, symbols, or combinations thereof.

23. The system for illuminating a self contained breathing apparatus whereby such illumination conveys a message to a third party according to claim 19 further including a transceiving device.

24. The system for illuminating a self contained breathing apparatus whereby such illumination conveys a message to a third party according to claim 23 wherein said transceiving device is in communication with a motion and position sensor.

25. The system for illuminating a self contained breathing apparatus whereby such illumination conveys a message to a third party according to claim 23 wherein said transceiving device is in communication with a global positioning system device.
